(19) United States
(12) Patent Application Publication
(10) Pub. No.: US 2004/0013483 A1
(43) Pub. Date: Jan. 22, 2004

(54) Device and method for installing an elongated member through a partition element

(76) Inventor: Michael Thomsen, Pandrup (DK)

Correspondence Address: CANTOR COLBURN, LLP, 55 GRIFFIN ROAD SOUTH, BLOOMFIELD, CT, 06002

(21) Appl. No.: 10/257,524

(22) PCT Filed: Apr. 11, 2001
(86) PCT No.: PCT/DK01/00256

(30) Foreign Application Priority Data
Apr. 14, 2000 (DK) PA 2000 00633
Oct. 25, 2000 (DK) PA 2000 01589

(51) Int. Cl. B23B 51/02

(52) U.S. Cl. 408/226

(57) ABSTRACT

The present invention concerns a method and a device for installing at least one flexible, elongated member through a partition element, said device comprising an elongated tool element with means for penetration at a first end of said tool element and a shaft portion at the second end of said tool element, and means for receiving the end portion of one or more elongated members, wherein the receiving means includes a hollow section extending at least through the shaft portion of the elongated tool element defining a tubular shaft portion open at the shaft end. By the present invention, a hitherto unknown device and method are provided for installing elongated members, such as a cable or a bunch of cables, wires or the like through a hole in a quick, easy, and careful manner.

The present invention relates to the field of installing an elongated member, such as a wire, a cable, a flexible tube or the like, through a partition element, such an internal or external wall or a ceiling in a building. The invention relates to a device and a method therefore.

From U.S. Pat. No. 5,529,443 a drill bit comprising a drilling head with rotary cutting edges and a shaft is known. At the end of the shaft, an opening is provided for receiving the end of a wire. This wire end is fixed to the shaft by a radially disposed set screw that must be tightened in order to clamp the wire end in the opening. The drill bit is drilled trough a wall and dismounted from the drilling machine. Subsequently, the wire end is secured to the shaft end and pulled through the wall together with the drill bit.

This solution is impractical in use, since the wire must be stripped of its insulation and the stripped end portion must then be firmly secured to the drill. Otherwise, it will fall of the drill bit when pulled through the hole in the wall. It is most difficult to tighten the set screw sufficiently in order to hold the wire end as it is pulled through the hole. This is particularly problematic if the partition member is a sandwich construction, such as a floor or double wall, e.g. an outer wall with an insulation material in between two wall elements. These disadvantages become more outspoken the larger the wire, cable or the like is in diameter and weight or the less flexible the wire is, just as the material inside the sandwich construction may provide a huge amount of friction which the fixation of the wire in the tool cannot withstand.

In addition to the above-mentioned disadvantages with installing cables through sandwich-constructed partition elements, e.g. installing an antenna, telephone or computer cables, etc. in a building, the tool according to U.S. Pat. No. 5,529,443 is unsuitable for installing a multiple of wires at the same time.

From U.S. Pat. No. 5,888,035, a tool for this purpose is also known. In a first embodiment, the tool includes a tubular cylinder with a removable drill bit. After having drilled a hole in the wall, the bit can be removed and a wire inserted through the tubular tool. However, the wire must be pushed through the tube and if the wall is thick, this may constitute a problem, in particular if the wire is flexible. This design is not very stable and strong and will not be suitable for penetrating different kinds of materials, just as there is a risk that the bit will fall out of the cylinder. This is particularly problematic if the partition element is a sandwich construction, e.g. a double wall, floor or ceiling with an inaccessible interior space. Moreover, it is impossible to pick up the wire end or even the drill bit if it falls into the cavity of the wall or floor due to the weight of the wire, cable or the like attached to the drill bit. The small drill bit cannot transport the removed material away from the hole, just as this drill assembly is unsuitable for hammer drilling, e.g. when drilling in brick work or concrete walls.

The object of the invention is to provide a device and a method which overcome the difficulties and disadvantages of the tools described above and to provide a device which may be used in connection with partition elements in different materials and of different thickness.

This object is achieved by a device for installing at least one flexible, elongated member through a partition element, said device comprising an elongated tool element with means for penetration at a first end of said tool element and a shaft portion at the second end of said tool element, and means for receiving the end portion of one or more elongated members, wherein the receiving means includes a hollow section extending at least through the shaft portion of the elongated tool element defining a tubular shaft portion open at the shaft end.

The invention also relates to a method of installing at least one flexible, elongated member through a partition element by using a device according to any of the 30 preceding claims, including the steps of: penetrating the partition element by the device from one side of the partition element to the other side thereof, inserting the end of the at least one flexible elongated member, such as a wire, cable or the like in the tubular shaft end of the device, and removing the device by pushing or pulling it through to the other side of the partition element, thereby leaving the at least one flexible elongated member threaded through the partition element.

By the present invention, a hitherto unknown device and method are provided for installing elongated members, such as a cable or a bunch of cables, wires or the like through a hole in a quick, easy, and careful manner. The invention is particularly suited for cable installation through a sandwich-constructed partition element, e.g. wall elements, floor or ceiling elements in a building, a boot, a vehicle etc.

The device may be inserted through the partition wall and whilst remaining in the created hole in the wall, the cable is inserted into the hollow shaft portion of the device. The device is positioned in the hole in such a manner that the shaft portion extends beyond the thickness of the wall. The device is penetrated through the wall on one side and removed from the other side. Thereby, the cable or other elongated members may be inserted into the device in such as way that the cables protrude out of the hole on the other side of the wall when the device is removed.

By the invention, it is possible to install a cable or the like through a partition element, irrespective of the kind of partition element. A device according to the invention is particularly suitable for installing elongated members through a sandwich construction as the device, and as a consequence the installation method, is unaffected by the content, such as insulation material, e.g. Rockwool®, of the hollow inner space in the wall construction.

Moreover, by the invention, no pulling or pushing of the cable is needed which eliminates the risk of damaging the cable in the process. Also, it is realised that a device according to the invention is suitable for installing a bunch or a multiple of individual wires, cables, etc. in one single process.

In the preferred embodiment of the invention, the tool element is substantially cylindrical in shape and preferably, the means for penetration is a helical cutting portion for drilling the tool element through the partition element. In this way, the device is embodied as a drilling tool that may be used as a normal drilling tool attached to a drilling machine in a conventional manner.

Preferably, the cutting portion and the shaft portion of the tool are provided with substantially the same external diameter. Hereby, a multipurpose drilling tool device is provided that may be used for other purposes than that of installing cables through a wall.

In a preferable embodiment of the invention, the second end of the tool element is provided with an adapter element for mounting said tool in a drilling apparatus or the like. Hereby, the tool element may be provided with a variety of diameters and coupled to the adapter mounted on a drilling machine. This means that a tool element with a larger diameter may be operated by normal drilling machines whose gripping clamps are restricted to drilling bores up to a certain size.

Preferably, at least the cutting portion is made of a steel material suitable for drilling in building materials, e.g. wood, concrete, metal or the like. Hereby, a device according to the invention may be specially suited for its typical utilities. In a particular use of the invention, a set of tool elements with different diameters and for different purposes may be provided so that cables of different diameters may be installed.

In an embodiment of a device according to the invention, the hollow section is provided with retention means for receiving and retaining the end section of an elongated flexible member. The retention means may be a leaf spring preferably provided at the bottom region of the hollow section. Hereby, the device is may be used for installing cables through vertically oriented holes, e.g. through the ceiling of a building, as the cable ends could otherwise slide out of the tubular shaft portion of the device. By using a leaf spring, the cable end is sufficiently retained and may easily be released.

The drive means for the device penetrating the partition element is removed after the step of penetration and the device is left in the resulting hole. Subsequently, the flexible member is inserted.

In a particular embodiment of the invention, a rubber sealing member is provided around the at least one flexible member prior to insertion thereof in the device in the partition element. Hereby, a sealed cable installation through a wall member is provided. Since the hole provided has a larger diameter than the cable diameter—irrespective of whether the cable is installed by a method according to the invention or any other method—a sealing must sometimes be provided in order to seal the hole, so that water or the like is prevented from penetrating into the wall construction. Hitherto, silicone or a similar filling material is used. However, these ways of sealing are neither very aesthetic nor efficient.

The invention will be described in detail below with reference to the accompanying drawings, in which

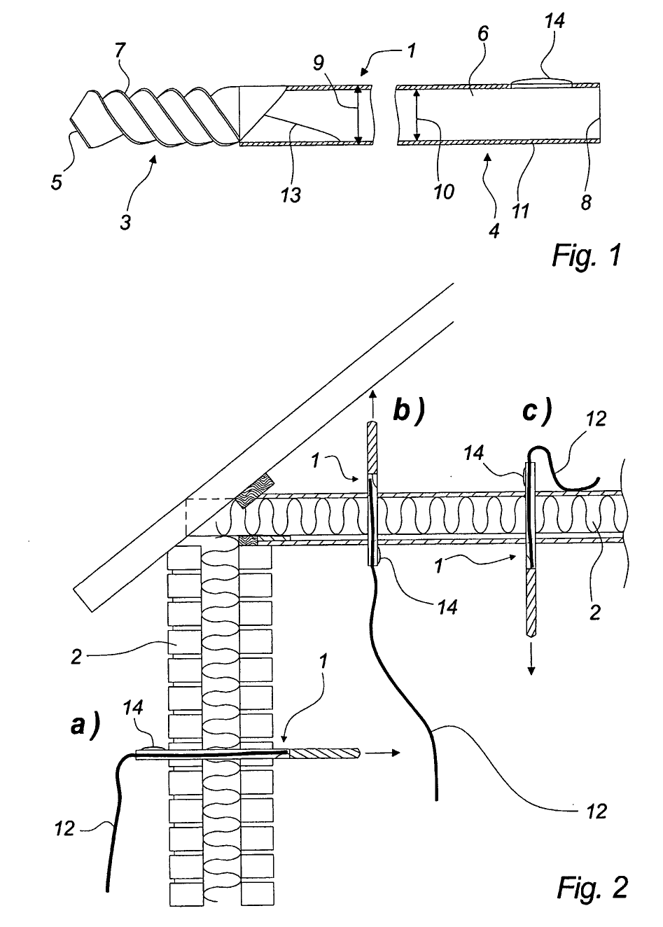

FIG. 1 shows a partial cut through a device according to a preferred embodiment of the invention,

FIG. 2 shows the device illustrated in FIG. 1 in three different situations,

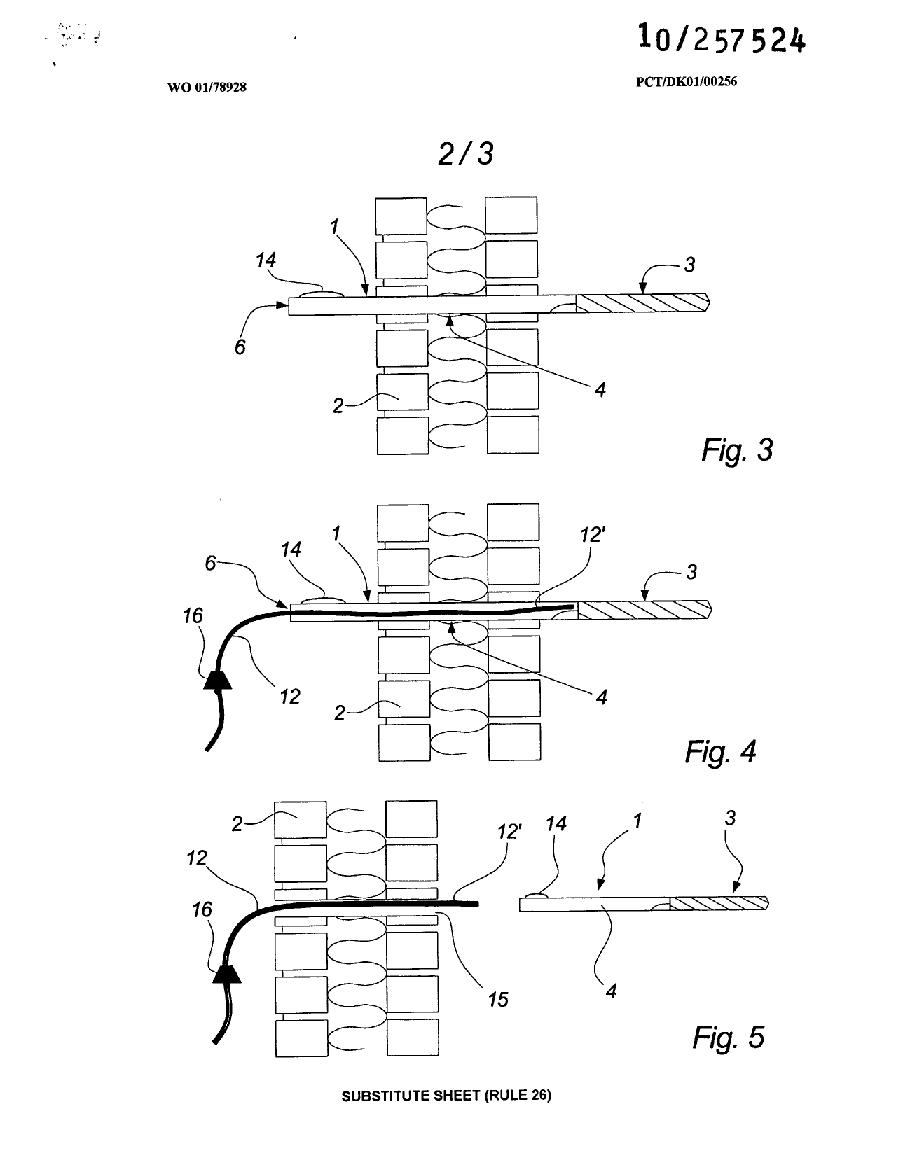

FIGS. 3 to 5 show the steps of a method of installing a cable, wire or the like,

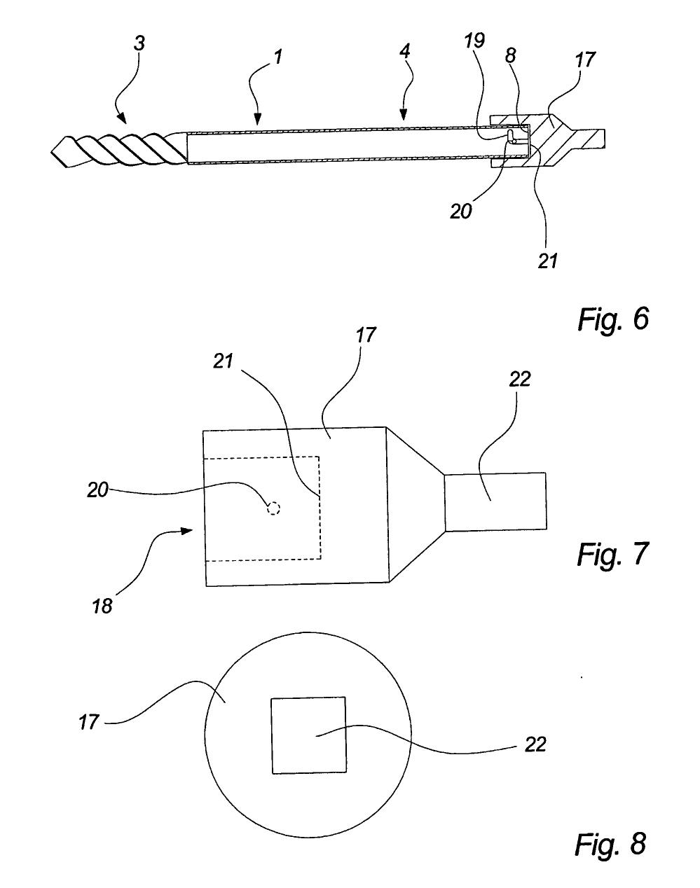

FIGS. 6 to 8 show a second embodiment of a device according to the invention.

FIG. 1 shows a tool element 1 comprising a drilling portion 3 with cutting edges 7 and a conic first end 5 of the tool element 1. The length of the drilling portion 3 corresponds to the thickness of the wall elements to be penetrated by the tool. The length of the drilling portion 3 is equal to or larger than the thickness of the wall element to be penetrated so that material may be removed from the drilling.

At the end of the solid cutting or drilling portion 3, a shaft portion 4 of the tool element 1 is concentrically provided and extends to a second end 8 of the tool element 1. The shaft portion 4 is tubular and defines a hollow inner space 6 that has an inner diameter 10. The outer diameter 9 of the shaft portion 4 is preferably identical with or less than the diameter of the cutting portion 3. In this way, the tool element 1 may function as a conventional drilling tool for drilling holes. The shaft portion 4 is chosen so that it is equal in length or longer than the overall thickness of the partition element 2. This means that the hollow cylinder 6 extends all the way through the partition element 2 when the tool element 1 is drilled through.

The shaft portion 4 is a cylindrical tube. On the outer perimeter, the shaft portion 4 may be provided with a protruding member 14, such as a leaf spring. The purpose of this leaf spring is to prevent the tool element 1 from falling out when positioned in the vertical direction.

Inside the shaft portion 4, retention means 13 may be provided. The retention means could be a leaf spring or a similar device which ensures that a cable 12 (see FIGS. 2 to 5) may be retained inside the tool element 1 and not slide out when the tool element 1 is pointing upwards (see FIG. 2, position b).

The cutting portion 3 and the shaft portion 4 are inseparably connected to each other e.g. by welding or soldering so that the two portions 3, 4 may be not separated from each other.

FIG. 2 shows the various positions of the tool element 1 in the partition element 2, such as wall—either an internal or an outer wall in a building—or a ceiling or a floor. The partition element 2 could also be other dividing plate structures in buildings, vehicles, boots etc. The invention is particularly suited for use in a partition element that is made as a sandwich construction, such as a double wall in a building where an insulation material is provided between an inner and an outer wall. In FIG. 2, three positions are shown. In position a), the tool element 1 is shown having penetrated the wall 2 in a horizontal direction and in positions b) and c), the device is shown when drilled through a ceiling in a vertical direction. In position b), it is shown in an upwards direction, and in position c) in a downwards direction. In all examples shown in FIG. 2, a cable 12 is inserted in the hollow shaft portion 4 of the tool element 1.

In FIGS. 3 to 5, three steps of the cable installation through a wall are shown. In FIG. 3, the tool element 1 is drilled through the wall element 2 so that the cutting portion 3 extends out on the other side of the wall 2. The first side of the wall 2 is where the tool element 1 was drilled into the wall 2. The hollow space 6 of the shaft portion 4 is accessible from the first side of the wall 2. As shown in FIG. 4, a cable 12 is then inserted into the tubular shaft portion 4. Since the hollow space 6 inside the shaft portion 4 extends all the way through the wall 2, the cable 12 ends inside the hollow space 6 with its end 12′ on the other side of the wall 2. When the cable 12 is inserted, the tool element 1 is pulled out of the hole 15 at the other side leaving the cable 12 lying in the hole 15 of the wall 2. The cable end 12′ is then exposed on the other side of the wall 2 and the cable can be pulled through. Thus, the difficulties with inserting a cable through a drilled hole are overcome in a simple manner.

As shown in FIGS. 4 and 5, the cable 12 may be provided with a rubber sealing member 16 threaded on the cable 12 before it is inserted into the hollow spacing 6. This sealing member 16 may be secured to the entrance on the hole 15 to prevent water etc. from penetrating into the wall 2. A similar sealing member 16 may be threaded on the cable 12, inserted through the hole 15 and used on the other side of the wall for sealing purposes.

In a second embodiment of the invention, the tool element 1 may be mounted in an adapter 17, as shown in FIG. 6. The adapter 17 is also shown in FIGS. 7 and 8. The adapter 17 is provided with a cylindrical receiving recess 18 where the end 8 of the shaft portion 4 of the tool element 1 is entered. The end 8 then abuts the bottom side of the recess 18 of the adapter 17. In the receiving recess 18, a locking pin 20 is traversally disposed in the opening. This locking pin 20 cooperates with two L-shaped grooves 19 (of which only one is visible in FIG. 6) cut at the end 8 of the shaft portion 4. As the tool element 1 is entered into the receiving recess, the locking pin 20 slides up the first path of the L-shaped grooves 19. When the end 8 abuts the bottom 21 of the recess 18, the tool element 1 is rotated in the same direction as that of the rotary cutting by the cutting portion 3. The locking pin 20 is hereby moved into the second, non-axial part of the grooves 19. Hereby, the tool element 1 is locked to the adapter 17 in a concentric position. The adapter 17 is provided with a gripping portion 22 for mounting the adapter 17 in a drilling machine (not shown). In this manner, the tool element 1 with one diameter of a device according to the invention may easily be released from the drilling machine, so that the cable may be inserted after drilling the necessary hole 15 in the partition element 2. The cross-sectional shape of the gripping portion may be square, as shown in FIG. 8, circular or any other suitable shape.

By the invention, it is understood that other advantageous embodiments that the ones described above may be provided without departing from the scope of the accompanying claims.

1. A device for installing at least one flexible, elongated member through a partition element, said device comprising
an elongated tool element with means for penetration at a first end of said tool element and a shaft portion at the second end of said tool element, and means for receiving the end portion of one or more elongated members,
characterised in that
the receiving means includes a hollow section extending at least through the shaft portion of the elongated tool element defining a tubular shaft portion open at the shaft end.

2. A device according to claim 1, wherein the tool element is substantially cylindrical in shape.

3. A device according to claim 1 or 2, wherein the means for penetration is a helical cutting portion for drilling the tool element through the partition element.

4. A device according to claim 3, wherein the cutting portion and the shaft portion of the tool are provided with substantially the same external diameter.

5. A device according to claim 3 or 4, wherein the second end of the tool element is provided with an adapter element for mounting said tool in a drilling apparatus or the like.

6. A device according to claim 3 to 5, wherein at least the cutting portion is made of a steel material suitable for drilling in building materials, e.g. wood, concrete, metal or the like.

7. A device according to any of the preceding claims, wherein the hollow section is provided with retention means for receiving and retaining the end section of an elongated flexible member.

8. A device according to claim 7, wherein the retention means is a leaf spring.

9. A device according to claim 7 or 8, wherein the retention means is provided at the bottom region of the hollow section.

10. A method of installing at least one flexible, elongated member through a partition element by using a device according to any of the preceding claims, including the steps of:
penetrating the partition element by means of the device from one side of the partition element to the other side thereof,
inserting the end of the at least one flexible elongated member, such as a wire, cable or the like in the tubular shaft end of the device, and
removing the device by pushing or pulling it through to the other side of the partition element, thereby leaving the at least one flexible elongated member threaded through the partition element.

11. A method according to claim 10, whereby the drive means for the device penetrating the partition element is removed after the step of penetration leaving the device in the resulting hole before insertion of the flexible member.

12. A method according to claim 10 or 11, whereby the partition element is an external wall, a ceiling or a similar building section.

13. A method according to any of the claims 10 to 12, whereby a rubber sealing member is provided around the at least one flexible member prior to insertion thereof in the device in the partition element.
